(19) United States
(12) Patent Application Publication
(10) Pub. No.: US 2026/0117902 A1
(43) Pub. Date: Apr. 30, 2026

(54) ROUND PIPE TO FLAT VENT ADAPTER FOR VAPOR MITIGATION IMPLEMENTATIONS

(71) Applicant: Vapor Remediation Technology, Blairstown, NJ (US)

(72) Inventors: Thomas E. HATTON, Blairstown, NJ (US); Douglas A. Brookes, JR., Dover, NJ (US); Matt KOCH, Chamblee, GA (US)

(21) Appl. No.: 19/368,851

(22) Filed: Oct. 24, 2025

Related U.S. Application Data
(60) Provisional application No. 63/712,042, filed on Oct. 25, 2024.

(51) Int. Cl. F16L 21/00

(52) U.S. Cl. CPC F16L 21/002

(57) ABSTRACT

Couplers and adapters for vapor mitigation implementation and systems for mitigating vapor are described herein. An example adapter includes a body defining a first section and a second section. The first section defines a first aperture that fluidically couples the first section with a first vapor mitigation conduit. The second section is in fluid communication with the first section and defines a second aperture that fluidically couples the second section with a second vapor mitigation conduit. At least a portion of the first section defines a circular cross-sectional shape, and at least a portion of the second section defines a rectangular cross-sectional shape. At least a portion of the second section defines a trapezoidal shape that evenly transitions a substantially rectangular airstream to substantially circular airstream.

### CROSS-REFERENCE TO RELATED APPLICATIONS

The present application claims priority to U.S. Provisional Application No. 63/712,042, filed on Oct. 25, 2024, the entirety of which is incorporated by reference herein.

### TECHNOLOGICAL FIELD

Example embodiments of the present disclosure relate generally to adapters and, more particularly, to pipe and vent adapters as used in example vapor mitigation systems.

### BACKGROUND

Vapor intrusion may refer to a process by which chemicals (e.g., volatile organic compounds (VOCs), methane, radon, and/or the like) in soil and/or groundwater mitigate to or seep into building spaces. As a result of vapor intrusion, the air within buildings may become contaminated, thereby exposing individuals within the buildings to chemical contamination, such as VOC and/or radon contamination. Complex installations of vapor mitigation implementations often require vapor mitigation conduit of various shapes which do not connect to each other without inhibiting airflow within the vapor mitigation conduit, thereby limiting the effectiveness of these vapor mitigation implementations. Through applied effort, ingenuity, and innovation, many of the problems associated with conventional connectors (e.g., couplers and adapters) used in vapor mitigation have been solved by developing solutions that are included in embodiments of the present disclosure, many examples of which are described in detail herein.

### BRIEF SUMMARY

Systems and devices are disclosed herein for pipe and vent connectors (e.g., collectively referred to herein as “adapters”), such as those used in vapor mitigation and remediation systems. An example adapter for use in such implementations may include a body defining a first section and a second section. The first section may define a first aperture configured to fluidically couple the first section with a first vapor mitigation conduit. The second section may be in fluid communication with the first section and define a second aperture configured to fluidically couple the second section with a second vapor mitigation conduit. At least a portion of the first section may define a circular cross-sectional shape, and at least a portion of the second section may define a rectangular cross-sectional shape.

In some embodiments, the second vapor mitigation conduit may include a vapor mat.

Additionally or alternatively, in some embodiments, the first vapor mitigation conduit may include a tubular body.

Additionally or alternatively, in some embodiments, the body may include a cavity for operatively coupling the first aperture to the second aperture, the cavity including contoured surfaces for reducing flow resistance.

Additionally or alternatively, in some further embodiments, the adapter may further include at least one drainage aperture in fluid communication with the cavity for exhausting (e.g., draining) condensate to an exterior of the adapter.

Additionally or alternatively, in some further embodiments, the cavity may be at least partially defined by a top wall and a bottom wall of the body.

Additionally or alternatively, in some further embodiments, the adapter may further include one or more drainage apertures in one or more of the top wall or the bottom wall of the body configured to exhaust (e.g., drain) condensate to an exterior of the adapter.

Additionally or alternatively, in some still further embodiments, the one or more drainage apertures in the top wall or the bottom wall may be formed in the second section.

Additionally or alternatively, in some embodiments, the first section and the second section are arranged such that the first vapor mitigation conduit and the second mitigation conduit are substantially aligned with one another.

Additionally or alternatively, in some embodiments, second section further comprises at least one knockout removable for selectively sizing a dimension of the second aperture.

Additionally or alternatively, in some embodiments, removing the at least one knockout allows for a third vapor mitigation conduit to be received therein.

Additionally or alternatively, in some further embodiments, the third vapor mitigation conduit may be in a stacked configuration with the second vapor mitigation conduit.

Additionally or alternatively, in some embodiments, the adapter may further include a marker connector configured to receive a marker therein.

Additionally or alternatively, in some embodiments, the first section may be substantially cylindrical.

Additionally or alternatively, in some embodiments, a cross-sectional area of the second section may taper along a longitudinal length of the body.

Additionally or alternatively, in some embodiments, a cross-sectional area of the second section proximate the first section may be less than a cross-sectional area of the second section opposite the first section.

Additionally or alternatively, in some embodiments, least a portion of the second section may define a trapezoidal shape that evenly transitions a substantially rectangular airstream to substantially circular airstream.

Additionally or alternatively, in some embodiments, the trapezoidal shaped chamber may be aerodynamically evenly shaped so as to facilitate the transition of a rectangular to a round airstream with minimal turbulence or induced drag.

Additionally or alternatively, in some embodiments, the trapezoidal shape in profile view may be mostly flat on top but may slope downward on the bottom to direct condensation to a condensate relief drain on the bottom of the body.

Additionally or alternatively, in some embodiments, the adapter may define round knockout panels on the round coupler side that may accommodate a plurality (e.g., up to three (3)) different pipe diameters, such as 3-inch, 4-inch, and/or 6-inch diameters.

Additionally or alternatively, in some embodiments, the second section that receives an example flat ventilation mat may define molded holes so a stake or spike may be driven though adapter and vent material and into the underlying soil to secure the adapter and vent mat to a fixed location.

Additionally or alternatively, in some embodiments, the adapter may define structural support cones positioned within the trapezoidal section of the airstream.

Additionally or alternatively, in some embodiments, the adapter may be formed of recyclable materials.

Additionally or alternatively, in some embodiments, the adapter may be formed of non-corrosive and/or non-oxidizing materials thus preventing degradation that may occur in harsh sub slab environments.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having described certain example embodiments of the present disclosure in general terms above, reference will now be made to the accompanying drawings. The components illustrated in the figures may or may not be present in certain embodiments described herein. Some embodiments may include fewer (or more) components than those shown in the figures.

FIG. 1A illustrates a first end view of an exemplary adapter (e.g., a round pipe to flat vent adapter for vapor mitigation), in accordance with one or more embodiments of the present disclosure;

FIG. 1B illustrates a side view of the adapter of FIG. 1A, in accordance with one or more embodiments of the present disclosure;

FIG. 1C illustrates a second end view of the adapter of FIG. 1A, in accordance with one or more embodiments of the present disclosure;

FIG. 1D illustrates a cross-sectional view of the adapter of FIG. 1A along line B-B, in accordance with one or more embodiments of the present disclosure;

FIG. 1E illustrates a cross-sectional view of the adapter of FIG. 1A along line A-A, in accordance with one or more embodiments of the present disclosure;

FIG. 2A illustrates a first end view of another exemplary adapter (e.g., another round pipe to flat vent adapter for vapor mitigation), in accordance with one or more embodiments of the present disclosure;

FIG. 2B illustrates a side view of the adapter of FIG. 2A, in accordance with one or more embodiments of the present disclosure;

FIG. 2C illustrates a second end view of the adapter of FIG. 2A, in accordance with one or more embodiments of the present disclosure;

FIG. 2D illustrates a cross-sectional view of the adapter of FIG. 2A along line D-D, in accordance with one or more embodiments of the present disclosure; and

FIG. 2E illustrates a cross-sectional view of the adapter of FIG. 2A along line C-C, in accordance with one or more embodiments of the present disclosure.

### DETAILED DESCRIPTION

### Overview

Various embodiments of the present disclosure will now be described more fully hereinafter with reference to the accompanying drawings in which some but not all embodiments are shown. Indeed, the present disclosure may be embodied in many different forms and should not be construed as limited to the embodiments set forth herein; rather these embodiments are provided so that this disclosure will satisfy applicable legal requirements. Like reference numerals refer to like elements throughout.

Vapor intrusion is a process by which chemicals (e.g., volatile organic compounds (VOCs), methane, radon, etc.) in soil and/or groundwater migrate to or seep into building spaces. These vapors can be released from contaminated soil and/or groundwater underneath buildings, and may enter basements, crawl spaces, rooms and/or other areas of a building or structure. As a result of vapor intrusion, the air within buildings may become contaminated, thereby exposing individuals within the buildings to chemical contamination, such as VOC and/or radon contamination.

Generally, VOCs are man-made chemical compounds that have a high vapor pressure and low water solubility. VOCs can be used and produced in the manufacture of fuels, paints, pharmaceuticals, and refrigerants, and are typically included in industrial solvents, paint thinners, tetrachloroethylene (dry cleaning fluid), fuel oxygenates (MTBE), and by-products produced by chlorination in water treatment. VOC contaminants can travel with or on top of groundwater and may easily become gaseous and migrate through soil. As a result of negative pressures that are induced by various building designs and features, VOCs can be drawn from the soil and/or groundwater, and into occupied spaces of buildings where human exposure can occur.

Radon is a Class A carcinogen that, according to scientific studies, may cause harmful effects on human lung tissue. Like VOCs, radon may be drawn into buildings from the underlying soil and/or groundwater by the negative pressures that are associated with the structure and features of buildings. Negative pressure can be caused by factors, such as temperature differentials where warm air exits an upper portion of a building (induces a stack effect), and wind and exhaust appliances that create additional vacuum. These forces can draw in VOC and/or radon gases through cracks, conduit openings and other pathways in slabs, sub-slabs or other flooring features of buildings.

To remedy vapor intrusion, a flow generator (e.g., a vacuum, pump, fan, or other air movement device) may be operatively coupled to vapor mitigation conduit to move the vapors from the substrate to a safe release area. Vapor mitigation conduit may include, for example, one or more sections of vapor mat. Complex installations, such as those contemplated by the present disclosure, may require collection and movement of the vapors from the rectangular vapor mitigation conduit to one or more additional cylindrical or “tubular conduit” (e.g., pipe, tubing, or the like). The effectiveness of a passive soil gas ventilation system (e.g., a vapor mitigation implementation) relies on airflow from a soil gas reservoir that exists as void space between the individual pieces of stone within a gravel bed that exists between, for example, a floor slab and the underlying soil. Similar to a round soil gas vent pipe, there is often a need to change the direction of rectangular vapor mitigation conduit material and its corresponding air/vapor flow. Because of the interior plastic cone support structure of the rectangular vapor mitigation conduit material, the open space within a vent through which air may be conveyed is reduced to approximately 5.6 square inches or about the equivalent of that of a 2.6 inch tubular conduit. Moreover, if the rectangular vapor mitigation conduit is miter cut and joined, the interior structural support cones are misaligned, further reducing the air flow rate, by causing air turbulence which induces drag.

The present disclosure is directed to adapters (e.g., adapters 100, 200, or the like) for connecting the rectangular vapor mitigation conduit to one or more tubular conduit, in various configurations, adjustability, features, or the like, as will be described henceforth, without the airflow and installation inefficiencies of traditional adapters. Indeed, the introduction of the disclosed adapters not only reduces the occurrence of time-consuming, ad-hoc field alterations by construction personnel, but also improves the efficiency and effectiveness of soil gas ventilation systems.

The adapters (e.g., adapters 100, 200, or the like, as described herein) may be fabricated from any suitable material or combination of materials. In some embodiments, any non-corrosive and/or non-oxidizing materials may be used to prevent degradation of adapters that can occur in harsh sub slab environments. The adapters may be fabricated of plastic, and manufactured through injection molding, blow molding, rotational molding, thermoforming, vacuum forming, compression molding, extrusion, machining of plastic stock, 3D printing, or the like. The plastic used may include thermoplastics such as ABS, polycarbonate, polypropylene, polyethylene, polyamide (nylon), polystyrene, Delrin, acrylic, thermoplastic polyurethane, or the like thermoplastic polymers or thermosetting materials such as epoxy, phenolic, melamine resins, or the like. Fabricated components of plastic may also include filled or reinforced plastics like glass-filled nylon, carbon fiber-reinforced ABS, mineral-filled polypropylene, or the like. In some embodiments, reclaimed (e.g., recycled) and/or further recyclable plastics may be used. For example, the use of recycled materials (e.g., recycled HDPE, LDPE, PET, or the like) may contribute to LEED points or other incentive programs which may qualify the owner for tax and other monetary benefits.

Additionally, or alternatively, an adapters may be a sheet metal part through processes such as stamping, bending, laser cutting, waterjet cutting, punching, or deep drawing, which may include the use materials including aluminum alloys (e.g., 5052, 6061), stainless steels (e.g., 304, 316), carbon steels (cold-rolled or hot-rolled), galvanized steels, copper, brass, titanium, or the like. Additionally, or alternatively, some or all of the fabricated components may be produced from metal stock using subtractive manufacturing techniques such as CNC milling, turning, drilling, grinding, electrical discharge machining, or the like, using ferrous or non-ferrous metals, high-strength low-alloy steels, tool steels, spring steels, alloys, or the like. Additionally, or alternatively the components described herein may be formed through casting or other manufacturing processes

Additionally, or alternatively, some or all of the fabricated components may be composed of composite materials. Composite compositions may include fiber-reinforced polymers with carbon, graphene, glass, aramid, natural fibers, or the like embedded therein. Additionally, or alternatively, some or all of the fabricated components may be produced using additive manufacturing methods such as fused deposition modeling, selective laser sintering, stereolithography, direct metal laser sintering, or the like processes, from polymeric, metallic, and/or composite feedstocks. Additionally, or alternatively, some or all of the fabricated components may be cast, forged, extruded, die cut, laminated, bonded from layers, or the like.

It should be appreciated that adapters may be composed of differing materials depending on functional requirements. For example, in some embodiments, certain adapters may be composed of metal while other certain fabricated components are composed of plastic or composite. In some embodiments, multiple certain adapters may be formed from a common material. In other embodiments, material selection may vary between the adapters to meet any design or performance requirements.

### Example Adapters

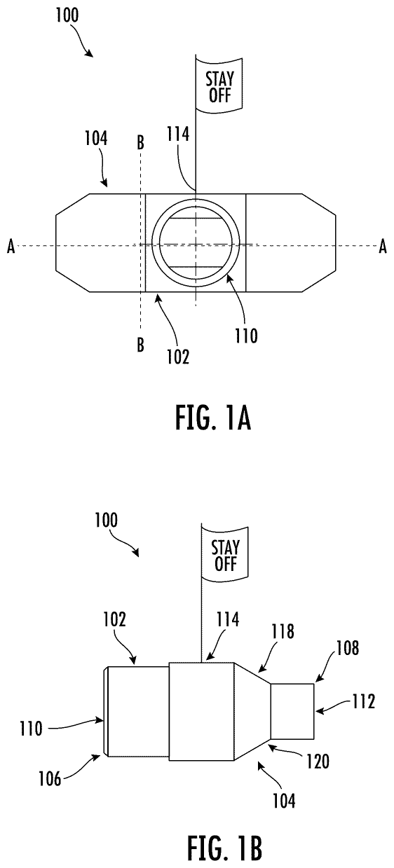

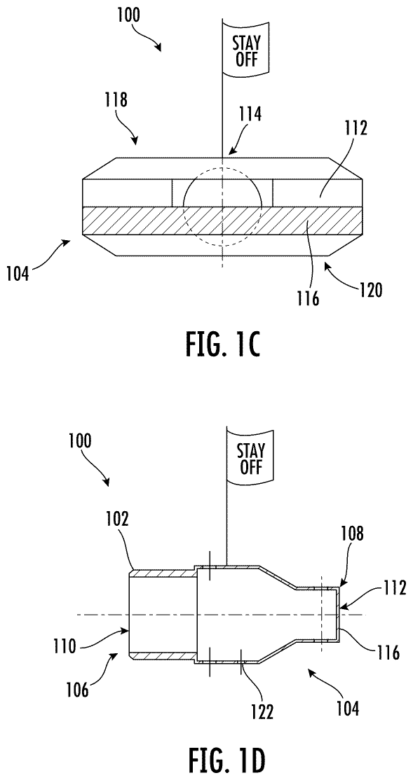

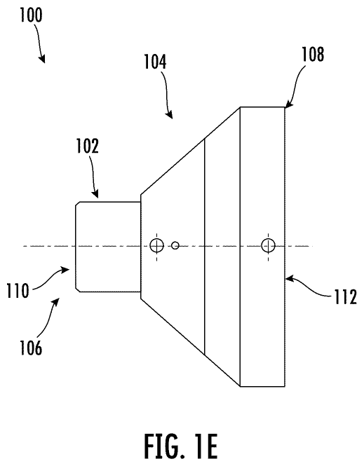

With reference to FIGS. 1A-1E, an exemplary adapter 100 is illustrated in accordance with one or more embodiments of the present disclosure. The adapter 100 may be defined by a body having a first section 102 for receiving a first vapor mitigation conduit (e.g., a first circular vapor mitigation conduit) and a second section 104 for receiving a second vapor mitigation conduit (e.g., a second rectangular vapor mitigation conduit). In some embodiments as shown, the first section 102 may define a substantially tubular body (e.g., a body formed of a cylindrical shape or otherwise comprising circular cross-sectional shapes). To receive the first vapor mitigation conduit (e.g., a circular conduit), the first portion 102 may include a first aperture 110 (e.g. opening or the like) defined by the first portion 102 at the first end 106 of the body. At least a portion of the first section 102 defines a circular cross-sectional shape. The present disclosure contemplates that the first aperture 110 may be dimensioned (e.g., sized and shaped) to interface with a first vapor mitigation conduit of any size (e.g., 3-in diameter, 4-inch diameter, 6-in diameter, and/or the like without limitation). As would be evident to one of ordinary skill in the art in light of the present disclosure, the first aperture 110 may include curved, angled, contoured wall portions, keying features, notches, or tapered surfaces that guide insertion or improve sealing engagement.

The second section 104 may be in fluid communication with the first section 102 and define a second aperture 112 (e.g., opening or the like) define by the second portion 102 at the second end 108 of the body. At least a portion of the second section 104 defines a rectangular cross-sectional shape (e.g. opposing long edges and opposing short edges, where the short edges extend generally vertical when the adapter 100 is oriented horizontally). The present disclosure contemplates that the second aperture 112 may be dimensioned (e.g., sized and shaped) to interface with a second vapor mitigation conduit of any size without limitation. As would be evident to one of ordinary skill in the art in light of the present disclosure, the second aperture 112 may also include curved, angled, contoured wall portions, keying features, notches, or tapered surfaces that guide insertion or improve sealing engagement.

As illustrated, the first section 102 and the second section 104 of the adapter 100 may be arranged such that the first vapor mitigation conduit and the second mitigation conduit are oriented substantially aligned to one another. Stated differently, a theoretical longitudinal axis extending from the first aperture 110 may be positioned approximately in line with from a theoretical longitudinal axis extending from the second aperture 112. Although described herein with reference to an aligned implementation, the present disclosure contemplates that the first vapor mitigation conduit and the second vapor mitigation conduit may be positioned at any relative location when coupled via the adapter 100. In some embodiments, one or more for the first or second vapor mitigation conduits may include a vapor mat. A vapor mat may refer to venting structure for facilitating the movement and dispersion of subsurface gases beneath slabs or other vapor barriers. An example vapor mat may take the form of a structured flat mat having a substantially rectangular cross section. Such a vapor mat may be supplied in a roll or sheet form cuttable to lengths required for a particular installation. As would be evident to one of ordinary skill in the art in light of the present disclosure, the adapters 100, 200 described herein may serve as an expansion transition chamber that reduces the turbulent flow drag as the airflow through the adapter 100, 200 enters the first section 102, 202 and into the first vapor mitigation conduit (e.g., a round pipe).

In some embodiments, an example vapor mat may may be constructed from a durable resin-based plastic having a repeating pattern of upwardly extending cones formed integrally with the bottom wall. These cones may create a network of interconnected voids that maintain air channels under imposed loads. The bottom wall of the vapor mat may include a distributed arrangement of apertures, allowing vapor to enter the conduit from below and/or moisture to pass through. Once inside, the vapor may move laterally through the internal void space. In some embodiments, the composite structure may be wrapped in geotextile material to facilitate a conveyance cavity.

To facilitate the fluid communication (e.g., the allowing of air flow) between the first aperture 110 and the second aperture 112, the body of the adapter 100 may be a hollow member defining a cavity (e.g., an air channel) therein for operatively coupling (e.g., fluidically coupling) the first aperture 110 to the second aperture 112. As such, one or more interior walls of the cavity (e.g., the interior of the body formed by the first section 102 and the second section 104) may be curved so as to facilitate airflow with reduced flow restriction and inducing only minimal turbulence and drag through the adapter 100. Additionally, or alternatively, the cavity may include one or more contoured surfaces (e.g., surface transitions) such as chamfers, fillets, radii, or the like, for further reducing flow restriction.

As shown in FIG. 1B, the second section 104 of the adapter 100 may define a top wall 118 and a bottom wall 120 opposite the top wall 118. In the embodiment of FIGS. 1A-1E, in a side view, the top wall 118 and the bottom wall 120 may each narrow (e.g., convene or otherwise become closer together) when moving from the first section 102 to the second end 108 of the second section 104. As shown in FIG. 1E, in a plan view, at least a portion of the second section 104 may define a trapezoidal shape that evenly transitions a substantially rectangular airstream to substantially circular airstream. For example, a cross-sectional area of the second section 104 in this plan view may taper along a longitudinal length of the body for the second section 104. Said differently, a cross-sectional area of the second section 104 proximate the first section 102 in the plan view is less than a cross-sectional area of the second section 104 opposite the first section 102 (e.g., at the second end 108).

As would be evident to one of ordinary skill in the art, the adapter 100 may be configured to transition one or more flat vent vapor mat(s) to a 2″, 3″, 4″, 6″ and/or the like round pipe or connect to a 2″, 3″, and/or 4″ round pipe riser stub up. A flat vent vapor mat may be, for example, 1″ height×12″ wide. The adaptor 100 of the present disclosure allows for the flat vent to be inserted into the rectangular end of the adaptor (e.g., the second end 108 of the second section 104). Once the flat vent is secured within the adaptor 100, a spike or vertical rod may be inserted through the adaptor and driven in the soil or fill material. The round side (e.g., first section 102) of the adaptor 100 may be configured to allow 2″, 3″, 4″ and/or 6″ round pipe to be inserted into the round coupler portion of the adaptor and be secured by adhesives, resin welded, or fixed fasteners such as screws. The 2″, 3″, and/or 4″ round pipe molded receiving couplers are part of the transition section and are sized to receive Schedule 40 and smaller standardized pipe diameters without limitation. Standardized pipe walls may be ¼ inch or less. The second end 108 of the second section 104 may further define at least one knockout 116 removable for selectively sizing a dimension of the second aperture 112, such as to receive a third vapor mitigation conduit (e.g., a double stacked implementation with two (2) vapor mats coupled with one adapter 100).

Referring back to FIGS. 1A-1E, the adapter 100 may include at least one securing aperture. A securing aperture may be any opening, hole, boss, raised feature, molded feature, or the like, that allows for passing of a substrate anchor (e.g., a stake, spike, or the like) therethrough. For example, a substrate anchor may be driven through the adapter 100, through the vapor mitigation conduit (and/or, in other embodiments the tubular conduit), and into the underlying substrate (e.g., soil, ground, fill material, or the like). By securing the adapter 100 via one or more substrate anchors, unwanted motion (e.g., twisting, turning, shifting, or the like) may be prevented. In some embodiments, use of the substrate anchor may secure the first vapor mitigation conduit or the second vapor mitigation conduit substantially stationary relative to the adapter by the substrate anchor being inserted through and extending through the first vapor mitigation conduit or the second vapor mitigation conduit.

In some embodiments, the adapter 100 may include one or more drainage apertures (e.g., condensate relief ports, conveyance apertures, etc.) 122. The one or more drainage apertures 122 may be in fluid communication with the cavity of the adapter 100 and mitigate the accumulation of condensate water (e.g., caused by air turbulence, temperature differentials, pressure differentials, rainfall, or the like) inside the cavity of the adapter 100 that could, if not evacuated, reduce airflow of the adapter. In some embodiments, the one or more drainage apertures 122 may extend through the top wall 118, bottom wall 120, or both, to provide for the draining of condensation to the underlying substrate. In some embodiments, the one or more drainage apertures 122 may be defined by the second section 104. Positions of the one or more drainage apertures 122 may vary by installation or adapter 100 geometry. The drainage apertures 122 may take one of several forms. In some embodiments, the drainage apertures 122 may be simple holes (e.g., round holes, square holes, or the like) provided in the top wall 118 and/or bottom wall 120. In other embodiments, a tubular member may extend between the top wall and the bottom wall to define a drainage passage. Additionally, or alternatively, one or more fittings may be installed within the drainage apertures 122.

Since adapters are sometimes covered with crushed stone or other fill materials, in some embodiments the adapter 100 may include a marker 114 that allows for the targeted uncovering of the adapter 100 or other component during inspection as part of the construction process. As used herein, a “marker” may refer to any element that extends upwardly and/or outwardly from the adapter 100 to provide a visible or otherwise detectable indication of the location of the adapter 100. In some embodiments, as shown graphically, the marker 114 may take the form of a flag extending from a marker connector. In other embodiments, the marker 114 may be a light, reflective member, antenna, or any other structure or device suitable for identifying or signaling the position of the adapter 100.

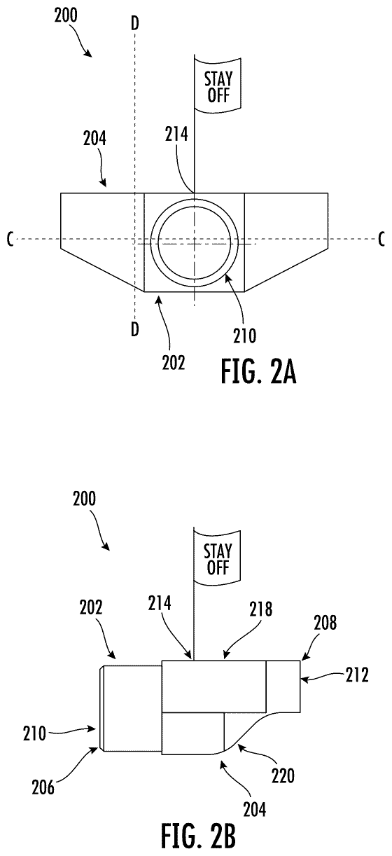

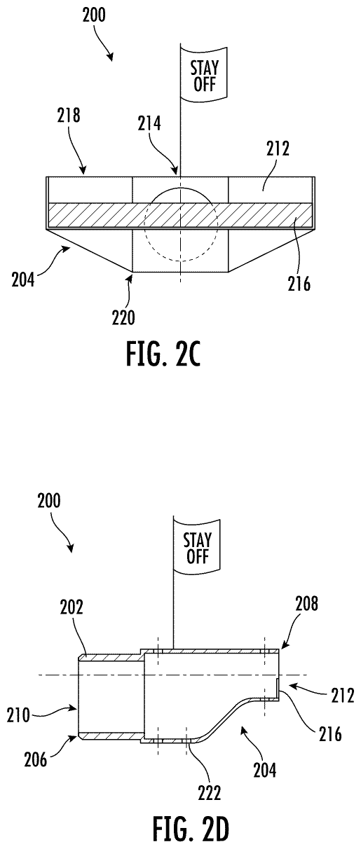

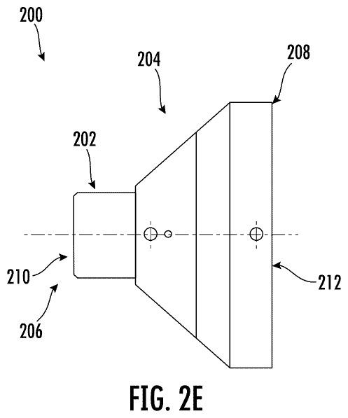

With reference to FIGS. 2A-2E, an exemplary adapter 200 is illustrated in accordance with one or more embodiments of the present disclosure. Similar to the adapter 100, the adapter 200 may be defined by a body having a first section 202 for receiving a first vapor mitigation conduit (e.g., a first circular vapor mitigation conduit) and a second section 204 for receiving a second vapor mitigation conduit (e.g., a second rectangular vapor mitigation conduit). In some embodiments as shown, the first section 202 may define a substantially tubular body (e.g., a body formed of a cylindrical shape or otherwise comprising circular cross-sectional shapes). To receive the first vapor mitigation conduit (e.g., a circular conduit), the first portion 202 may include a first aperture 210 (e.g. opening or the like) defined by the first portion 202 at the first end 206 of the body. At least a portion of the first section defines a circular cross-sectional shape. The present disclosure contemplates that the first aperture 210 may be dimensioned (e.g. sized and shaped) to interface with a first vapor mitigation conduit of any size (e.g., 3-in diameter, 4-inch diameter, 6-in diameter, and/or the like without limitation). As would be evident to one of ordinary skill in the art in light of the present disclosure, the first aperture 210 may include curved, angled, contoured wall portions, keying features, notches, or tapered surfaces that guide insertion or improve sealing engagement.

The second section 204 may be in fluid communication with the first section 202 and define a second aperture 212 (e.g. opening or the like) define by the second portion 202 at the first second 208 of the body. At least a portion of the second section defines a rectangular cross-sectional shape (e.g. opposing long edges and opposing short edges, where the short edges extend generally vertical when the adapter is oriented horizontally). The present disclosure contemplates that the second aperture 212 may be dimensioned (e.g. sized and shaped) to interface with a second vapor mitigation conduit of any size without limitation. As would be evident to one of ordinary skill in the art in light of the present disclosure, the second aperture 212 may also include curved, angled, contoured wall portions, keying features, notches, or tapered surfaces that guide insertion or improve sealing engagement.

As illustrated, the first section 202 and the second section 204 of the adapter 200 may be arranged such that the first vapor mitigation conduit and the second mitigation conduit are oriented substantially aligned to one another. Stated differently, a theoretical longitudinal axis extending from the first aperture 210 may be positioned approximately in line with from a theoretical longitudinal axis extending from the second aperture 212. Although described herein with reference to an aligned implementation, the present disclosure contemplates that the first vapor mitigation conduit and the second vapor mitigation conduit may be positioned at any relative location when coupled via the adapter 200.

To facilitate the fluid communication (e.g., the allowing of air flow) between the first aperture 210 and the second aperture 212, the body of the adapter 200 may be a hollow member defining a cavity (e.g., an air channel) therein for operatively coupling (e.g., fluidically coupling) the first aperture 210 to the second aperture 212. As such one or more interior walls of the cavity (e.g., the interior of the body formed by the first section 202 and the second section 204) may be curved so as to facilitate airflow with reduced flow restriction and inducing only minimal turbulence and drag through the adapter 200. Additionally, or alternatively, the cavity may include one or more contoured surfaces (e.g., surface transitions) such as chamfers, fillets, radii, or the like, for further reducing flow restriction.

As shown in FIG. 2B, the second section 204 of the adapter 200 may define a top wall 218 and a bottom wall 220 opposite the top wall 218. In the embodiment of FIGS. 2A-2E, in a side view, the top wall 218 may remain substantially flat in the side view while the bottom wall 220 may narrow (e.g. convene or otherwise become closer to the top wall 218 when moving from the first section 202 to the second end 208 of the second section 204. The transition of the bottom wall 220 may be curved along the interior of the body so as to reduce the turbulence of the air therein. As shown in FIG. 2E, in a plan view, at least a portion of the second section 204 may define a trapezoidal shape that evenly transitions a substantially rectangular airstream to substantially circular airstream. For example, a cross-sectional area of the second section 204 in this plan view may taper along a longitudinal length of the body for the second section 204. Said differently, a cross-sectional area of the second section 204 proximate the first section 202 in the plan view is less than a cross-sectional area of the second section 204 opposite the first section 202 (e.g., at the second end 208).

As would be evident to one of ordinary skill in the art, the adapter 200 may be configured to transition one or more flat vent vapor mat(s) to a 2″, 3″, and/or 4″ round pipe or connect to a 2″, 3″, and/or 4″ round pipe riser stub up. A flat vent vapor mat may be typically 1″ height×12″ wide. The adaptor 200 of the present disclosure allows for the flat vent to be inserted into the rectangular end of the adaptor (e.g., the second end 208 of the second section 204). Once the flat vent is secured within the adaptor 200, a spike or vertical rod may be inserted through the adaptor and driven in the soil or fill material. The round side (e.g., first section 202) of the adaptor 200 may be configured to allow 2″, 3″, and/or 4″ round pipe to be inserted into the round coupler portion of the adaptor and be secured by adhesives, resin welded, or fixed fasteners such as screws. The 2″, 3″, and/or 4″ round pipe molded receiving couplers are part of the transition section and are sized to receive Schedule 40 and smaller standardized pipe diameters without limitation. Standardized pipe walls may be ¼ inch or less. The second end 208 of the second section 204 may further define at least one knockout 216 removable for selectively sizing a dimension of the second aperture 212, such as to receive a third vapor mitigation conduit (e.g., a double stacked implementation with two (2) vapor mats coupled with one adapter 200).

Referring back to FIGS. 2A-2E, the adapter 200 may include at least one securing aperture. A securing aperture may be any opening, hole, boss, raised feature, molded feature, or the like, that allows for passing of a substrate anchor (e.g., a stake, spike, or the like) therethrough. For example, a substrate anchor may be driven through the adapter, through the vapor mitigation conduit (and/or, in other embodiments the tubular conduit), and into the underlying substrate (e.g., soil, ground, fill material, or the like). By securing the adapter 200 via one or more substrate anchors, unwanted motion (e.g., twisting, turning, shifting, or the like) may be prevented. In some embodiments, use of the substrate anchor may secure the first vapor mitigation conduit or the second vapor mitigation conduit substantially stationary relative to the adapter by the substrate anchor being inserted through and extending through the first vapor mitigation conduit or the second vapor mitigation conduit.

In some embodiments, the adapter 200 may include one or more drainage apertures (e.g., condensate relief ports, conveyance apertures, etc.) 222. The one or more drainage apertures 222 may be in fluid communication with the cavity of the adapter 200 and mitigate the accumulation of condensate water (e.g., caused by air turbulence, temperature differentials, pressure differentials, rainfall, or the like) inside the cavity of the adapter 200 that could, if not evacuated, reduce airflow of the adapter. In some embodiments, the one or more drainage apertures 222 may extend through the top wall 218, bottom wall 220, or both, to provide for the draining of condensation to the underlying substrate. In some embodiments, the one or more drainage apertures 222 may be defined by the second section 204. Positions of the one or more drainage apertures 222 may vary by installation or adapter 200 geometry. The drainage apertures 222 may take one of several forms. In some embodiments, the drainage apertures 222 may be simple holes (e.g., round holes, square holes, or the like) provided in the top wall 218 and/or bottom wall 220. In other embodiments, a tubular member may extend between the top wall and the bottom wall to define a drainage passage. Additionally, or alternatively, one or more fittings may be installed within the drainage apertures 222.

Since adapters are sometimes covered with crushed stone or other fill materials, in some embodiments the adapter 200 may include a marker 214 that allows for the targeted uncovering of the adapter 200 or other component during inspection as part of the construction process. As used herein, a “marker” may refer to any element that extends upwardly and/or outwardly from the adapter 200 to provide a visible or otherwise detectable indication of the location of the adapter 200. In some embodiments, as shown graphically, the marker 214 may take the form of a flag extending from a marker connector. In other embodiments, the marker 214 may be a light, reflective member, antenna, or any other structure or device suitable for identifying or signaling the position of the adapter 200.

Unless otherwise defined, all terms (including technical and scientific terms) used herein have the same meaning as commonly understood by one of ordinary skill in the art to which this disclosure belongs. It will be further understood that the terms used herein should be interpreted as having a meaning that is consistent with their meaning in the context of this specification and the relevant art and should not be interpreted in an idealized or overly formal sense unless expressly so defined herein. Certain terminology is used herein for convenience only and is not to be taken as a limitation on the disclosure. For example, words such as “upper,” “lower,” “left,” “right,” “horizontal,” “vertical,” “upward,” and “downward” merely describe the configuration shown in the figures. The referenced components may be oriented in an orientation differently that shown in the drawings and the terminology, therefore, should be understood as encompassing such variations unless specified otherwise.

It will be understood that when an element is referred to as being “connected,” “coupled,” or “operatively coupled” to another element, the elements can be formed integrally with each other, or may be formed separately and put together. Furthermore, “connected,” “coupled,” or “operatively coupled” to can mean the element is directly connected, coupled, or operatively coupled to the other element, or intervening elements may be present between the elements. Furthermore, “connected,” “coupled,” or operatively coupled” may mean that the elements are detachable from each other, or that they are permanently coupled together.

Many modifications and other embodiments of the present disclosure will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the embodiments are not to be limited to the specific embodiments disclosed and that modifications and other embodiments are intended to be included within the scope of the appended claims. Although specific terms are employed herein, they are used in a generic and descriptive sense only and not for purposes of limitation.

1. An adapter for vapor mitigation conduit, the adapter comprising:
a body defining:
a first section, wherein the first section defines a first aperture configured to fluidically couple the first section with a first vapor mitigation conduit; and
a second section in fluid communication with the first section, wherein the second section defines a second aperture configured to fluidically couple the second section with a second vapor mitigation conduit,
wherein at least a portion of the first section defines a circular cross-sectional shape and at least a portion of the second section defines a rectangular cross-sectional shape.

2. The adapter of claim 1, wherein the second vapor mitigation conduit comprises a vapor mat.

3. The adapter of claim 1, wherein the first vapor mitigation conduit comprises a tubular body.

4. The adapter of claim 1, wherein the body comprises a cavity for operatively coupling the first aperture to the second aperture, the cavity comprising contoured surfaces for reducing flow resistance.

5. The adapter of claim 4, further comprising at least one drainage aperture in fluid communication with the cavity for exhausting condensate to an exterior of the adapter.

6. The adapter of claim 4, wherein the cavity is at least partially defined by a top wall and a bottom wall of the body.

7. The adapter of claim 6, further comprising one or more drainage apertures in one or more of the top wall or the bottom wall of the body configured to exhaust condensate to an exterior of the adapter.

8. The adapter of claim 7, wherein the one or more drainage apertures in the top wall or the bottom wall are formed in the second section.

9. The adapter of claim 1, wherein the first section and the second section are arranged such that the first vapor mitigation conduit and the second mitigation conduit are substantially aligned with one another.

10. The adapter of claim 1, wherein the second section further comprises at least one knockout removable for selectively sizing a dimension of the second aperture.

11. The adapter of claim 10, wherein removing the at least one knockout allows for a third vapor mitigation conduit to be received therein.

12. The adapter of claim 11, wherein the third vapor mitigation conduit is in a stacked configuration with the second vapor mitigation conduit.

13. The adapter of claim 1, further comprising a marker connector configured to receive a marker therein.

14. The adapter of claim 1, wherein the first section is substantially cylindrical.

15. The adapter of claim 1, wherein a cross-sectional area of the second section tapers along a longitudinal length of the body.

16. The adapter of claim 1, wherein a cross-sectional area of the second section proximate the first section is less than a cross-sectional area of the second section opposite the first section.

17. The adapter of claim 1, wherein at least a portion of the second section defines a trapezoidal shape that evenly transitions a substantially rectangular airstream to substantially circular airstream.

18. A system for mitigation of vapors in a substrate, the system comprising:
a first vapor mitigation conduit proximate a substrate;
a second vapor mitigation conduit;
an adapter comprising:
a body defining:
a first section, wherein the first section defines a first aperture configured to fluidically couple the first section with the first vapor mitigation conduit; and
a second section in fluid communication with the first section, wherein the second section defines a second aperture configured to fluidically couple the second section with the second vapor mitigation conduit,
wherein at least a portion of the first section defines a circular cross-sectional shape and at least a portion of the second section defines a rectangular cross-sectional shape.

19. The system of claim 18, rein a cross-sectional area of the second section proximate the first section is less than a cross-sectional area of the second section opposite the first section.

20. The system of claim 19, wherein at least a portion of the second section defines a trapezoidal shape that evenly transitions a substantially rectangular airstream to substantially circular airstream.
